(19) United States
(12) Patent Application Publication
(10) Pub. No.: US 2007/0297607 A1
(43) Pub. Date: Dec. 27, 2007

(54) Video distribution system

(76) Inventors: Shinya Ogura, Tokyo (JP); Sumie Nakabayashi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/797,599

(22) Filed: May 4, 2007

(30) Foreign Application Priority Data
Jun. 21, 2006 (JP) 2006-171062

(51) Int. Cl. H04N 7/167; H04L 9/00

(52) U.S. Cl. 380/239; 380/44

(57) ABSTRACT

A video distribution system that distributes encrypted video data, using improved encryption keys. A master content key is set as the highest-order key. One or more elements (unique camera ID, generation number, access list, time), and the order thereof, are set for the generation of keys (unique camera key, camera generation key, channel key, session key) that are of a lower order than the highest-order key. A hierarchical key system is used that is implemented by using element by element to generate keys of a gradually lower order than the highest-order key in accordance with the set order of the elements. The lowest-order key (session key) is used for data encryption and decryption.

### BACKGROUND OF THE INVENTION

1. Field of the Invention

This invention relates to a video distribution system that encrypts video images taken by a video camera such as a monitoring camera and transmits, receives and records the video images. It particularly relates to a video distribution system that uses an improved key for encryption.

2. Description of the Prior Art

To prevent criminal activities and accidents, video monitoring systems are installed in hotels, convenience stores, financial institutions and other such premises, and on public facilities such as dams and roads. These video monitoring systems perform the monitoring using video cameras from which video pictures are transmitted to a monitoring center, such as a control or security room, where the video images are inspected and action taken as required, and the video may also be recorded and stored.

In recent years, network type video monitoring systems are becoming more widespread in which the monitoring is performed by digitizing and transmitting the monitoring camera images over an IP network such as the Internet.

Nowadays, the monitoring images are distributed live over the network, sent to a video receiver from a video transmitter connected to the monitoring camera. The transmitted video (and audio) is constantly monitored by monitoring personnel who take action in response to any problems that arise.

In addition to this type of live monitoring system, there are recording type monitoring systems in which the monitor video is recorded and stored and used to review the time at which a problem occurs. Recording type monitoring systems are mainly used by financial institutions and shops.

Network type video monitoring systems can use video storage and distribution servers that are able to handle recording type monitoring requirements.

To prevent unauthorized interception such as eavesdropping, there is growing use of encrypted network type video monitoring systems in which the video data flowing over the network is encrypted and can only be inspected using a video receiver having the decryption key.

FIG. 7 shows an example of the configuration of an encrypted network type video monitoring system. Elements that are the same as, or similar to, those used in the configuration shown in FIG. 1, which is an example of an embodiment of the present invention, are denoted by the same reference numerals. It is to be understood that the present invention is not limited thereby. Also, the inventors are aware that the above technology is already known, but in the absence of any appropriate reference material do not list specific prior art references.

When there is a plurality of video transmitters 3, each will normally be given its own, unique key. It is therefore necessary to prepare as many keys as there are video transmitters 3, and to store beforehand in the key management PC 8 the corresponding decryption keys. In such a case, when there are many video transmitters 3, the work and effort required to store the many key values beforehand are increased, and the amount of storage memory required is also increased, which has been a problem.

FIG. 8 shows an example of the information in memory when key values are held in the key management PC 8. In this example, a 64-digit hexadecimal encryption key value is assigned to each of the video transmitters 3 affixed to cameras having the unique IDs “Front Gate Surveillance Camera 1”, “Front Gate Surveillance Camera 2”, “Service Entrance Monitor Camera”, and “Southside Road Monitor Camera”.

The encryption key set in each video transmitter 3 can be changed if it is leaked or the like. In such a case, the video information recorded on the recording medium 7 of the video storage and distribution server 6 will contain a mixture of video data encrypted by the previous encryption key and video data encrypted by the current encryption key.

In order to replay previous video data, the video receiver 4 therefore has to use the previous encryption key to perform the decryption. When encryption keys are changed numerous times, it requires that many decryption keys be set in the video receiver 4, which has been a problem in that it takes more time and effort and increases the amount of storage memory needed.

Moreover, assuming that each video transmitter 3 is a device that continuously transmits video and audio data in units of several tens of milliseconds, changing the encryption key in the video transmitter 3 must be timed with a precision measured in milliseconds, which is difficult and complex, and sometimes impossible.

FIG. 9 shows an example of a screen used for setting keys in the video receiver 4. Elements that are the same as, or similar to, those used in the configuration shown in FIG. 5, described later with reference to the embodiment of the present invention, are denoted by the same reference numerals. It is to be understood that the explanation does not limit the invention.

Displayed on the setting screen of FIG. 9 are a set button 21, a unique camera ID input column 22, a key change time input column 41 and a key value input column 42. The set button 21 is used to confirm the content input to each column and instruct the system to hold the content in the internal memory of the video receiver 4. The unique ID of each camera is input to the camera ID input column 22. The times at which keys are changed in each video transmitter 3 are input to the key change time input column 41; in the illustrated example, the year, month, day, hour, minute, second and millisecond are input. Key values are input to the key value input column 42, as a hexadecimal 64-digit value, in the example of FIG. 9.

Specifically, with reference to FIG. 9, the key of the video transmitter 3 of Front Gate Surveillance Camera 1 is changed three times. In this example, the key value used for encryption until 2005/07/20 01:23:45:678 is CA86E703CE830699 209949D485AEF52E 14B71D8494AC27F6 15AE0CD67B740094. In the same way, there is the key value after that which is used until 2005/12/31 02:34:56:789, and the key value after that which is used until 2006/01/16/23:59:59:999, and the newest key value, for a total of four key values, which have to be set in the video receiver 4.

In cases in which encryption is performed using a plurality of keys simultaneously, such as when encryption is performed using a different key for each user (video receiver), or when different keys are used for the encryption of video and audio data (herein, encryption target differences in the same video receiver is called an “access list”), a plurality of key values has to be set in the video transmitters 3, which takes time and effort and requires more memory.

FIG. 10 shows an example of a screen used for setting keys in a video transmitter 3. Elements that are the same as, or similar to, those used in the configuration shown in FIG. 6, described later with reference to the embodiment of the present invention, are denoted by the same reference numerals. It is to be understood that the explanation does not limit the invention.

Displayed on the setting screen of FIG. 10 are a set button 31, an access list input column 51 and a key value input column 52. The set button 31 is used to confirm the content input to each column and instruct the system to hold the content in the internal memory of the video transmitter 3. The access list is input to the access list input column 51 and the key values are input to the key value input column 52. In the example of FIG. 10, different key values are used for the video access list and audio access list.

Even when there is no leakage of keys, to guard against the possibility of the encryption system becoming compromised the keys in the video transmitter 3 and video receiver 4 are sometimes changed, which necessitates the task of resetting the keys of each video transmitter 3 and video receiver 4. In an encrypted video monitoring system, the task of rigorously managing the keys falls on the key administrator. However, a large number of setting and saving operations imposes a major burden on the system administrator. In addition, as a result of advances in cryptanalysis technology, the data length of key values is constantly increasing, so that storing numerous keys has become a major burden for some systems equipment.

To resolve the above problems, the object of the present invention is to provide a video distribution system that uses an improved encryption key. Specifically, the object of this invention is to reduce the number of keys that has to be set and stored, making it possible to effectively set a plurality of keys with respect also to system equipment having a small amount of memory in which to store keys.

### SUMMARY OF THE INVENTION

To attain the above object, this invention provides a video distribution system for distributing encrypted video data, in which data encryption and decryption are performed using a lowest-order key generated by a system that uses hierarchical keys obtained in a case in which a highest-order key is set, one or more elements and an order thereof are set, and the elements are used one by one to generate keys of a gradually lower order than the highest-order key in accordance with the order of the elements.

Making the encryption and decryption keys hierarchical reduces the number of keys a system administrator has to set and store, and makes it possible to effectively set a plurality of keys in the case of system equipment having a small amount of key storage space. Specifically, not setting lowest-order keys, and instead setting equipment keys that are higher-order than the lowest-order keys, makes it possible to generate lowest-order keys using those keys and elements, thereby decreasing the number of keys that are set and stored.

Various numbers of key hierarchies may be used, such as three comprised of highest-order keys, lowest-order keys and intermediate (mid-order) keys, or two comprised of just highest-order keys and lowest-order keys. Various types of key order and elements may be used. Similarly, various key encryption and decryption systems may be used.

As one example, the video distribution system of this invention may be constituted by a transmitter that transmits encrypted data and a receiver that receives encrypted data. The transmitter has transmission-side storage means for storing a specific key of a higher order than a lowest-order key, transmission-side generation means for generating a lowest-order key, using the key stored in the transmission-side storage means and one or more elements, encryption means for encrypting data, using a lowest-order key generated by the transmission-side generation means, and transmission means for transmitting the data encrypted by the encryption means and the element information for generating the key used in the encryption.

The receiver has receiving means for receiving the encrypted data and the element information, receiving-side storage means for storing a specific key of a higher order than a lowest-order key, receiving-side generation means for generating a lowest-order key using the key stored in the receiving-side storage means and the elements specified by the information received by the receiving means, and decryption means for decrypting the encrypted data received by the receiving means, using the lowest-order key generated by the receiving-side generation means.

Thus, the transmitter uses not the lowest-order key, but a key of a higher order than the lowest-order key, and the elements, to generate a lowest-order key, uses that key to encrypt the data, and transmits (sends) the encrypted data and element information. This is received by the receiver, which uses not the lowest-order key but a key of a higher order than the lowest-order key and the elements, based on the received information, to generate a lowest-order key, and uses that key to decrypt the data, enabling encrypted communications without presetting lowest-order keys in each device.

As the specific key of a higher order than the lowest-order key stored in the transmitter, and the key of a higher order than the lowest-order key stored in the receiver, there may be used various types of keys. For example, the keys stored in the transmitter and receiver may be different keys, or the same keys may be used.

As the element information communicated from the transmitter to the receiver, there may be used, for example, all of the element information needed to generate, from the highest-order key, the lowest-order key used for the encryption of the data by the transmitter. Alternatively, if the necessary lowest-order key can be generated in the receiver, just a part of the element information may be used instead of all of the element information.

The element information needed to generate the lowest-order key may be stored beforehand in the transmitter, or it may be detected internally, or externally acquired. A relay apparatus such as a store-and-forward apparatus may be provided between the transmitter and receiver. In such a case, encrypted data and elements sent by the transmitter would be received and temporarily stored by the store-and-forward apparatus, and then forwarded to the receiver. The store-and-forward apparatus may be set to transmit the data and element information at prescribed periods, or it may be sent in response to a request from the receiver or the like.

As one example, the video distribution system of the invention also comprises a configuration in which the above elements are one or more selected from among an originator identification value that identifies the originator of the encrypted data, a number-of-updates identification value that identifies the number of times a key has been updated at the originator of the encrypted data, and a type identification value that identifies the data type. Thus, various values may be used as the elements for generating hierarchical keys. As data types, various types may be used, such as video, audio and text media, types of users that handle the data, and so forth.

The video distribution system of the invention also comprises a configuration in which the above elements are an originator identification value that identifies the originator of the encrypted data, a number-of-updates identification value that identifies the number of times a key has been updated at the originator of the encrypted data, a type identification value that identifies the data type, and a time identification value that identifies the time, used going from higher to lower order. Thus, keys of each hierarchical level can be generated by using these various values, in order, as the elements.

The video distribution system of the invention also comprises a configuration in which the elements used are at least an originator identification value that identifies the originator of the encrypted data and a number-of-updates identification value that identifies the number of times a key has been updated at the originator of the encrypted data, a key generated using the number-of-updates identification value is stored in the encrypted data transmission-side storage means, and a key generated using the originator identification value is stored in the encrypted data receiving-side storage means. This arrangement enables different hierarchical keys, each suited to the task, to be stored on the transmitter and receiver, simplifying the administration of the hierarchical keys.

This invention may also be provided as a method, program or recording medium or the like. A method according to the invention executes the processing operations of the various means of the system apparatus. A program according to the invention is executed by a computer comprising the system apparatus, with the computer effecting the various system functions. Providing the invention in the form of a recording medium refers to the computer program recorded on a medium that can be read by the input means of a computer to thereby by executed by the computer.

As described in the foregoing, when distributing encrypted video data, the video distribution system according to the present invention uses a hierarchical key system for data encryption and decryption, making it possible to efficiently set and manage the keys.

### BRIEF EXPLANATION OF THE DRAWINGS

FIG. 1 is a diagram showing the arrangement of an embodiment of the video distribution system according to the present invention.

FIG. 2 (a) shows an example of key generation and (b) shows an example of a key ID configuration, in an embodiment of the invention.

FIG. 3 shows an example of the processing in an embodiment of the video distribution system according to the invention.

FIG. 4 shows an example of the information stored in the memory of a key management PC in an embodiment of the invention.

FIG. 5 shows an example of a key setting screen in the video receiver of an embodiment of the invention.

FIG. 6 shows an example of a key setting screen in the video transmitter of an embodiment of the invention.

FIG. 7 shows a video distribution system configuration.

FIG. 8 shows an example of the information stored in the memory of the key management PC.

FIG. 9 shows an example of the key setting screen of the video receiver.

FIG. 10 shows an example of the key setting screen of the video transmitter.

### DESCRIPTION OF THE PREFERRED EMBODIMENTS

An embodiment of the invention will now be described with reference to the drawings.

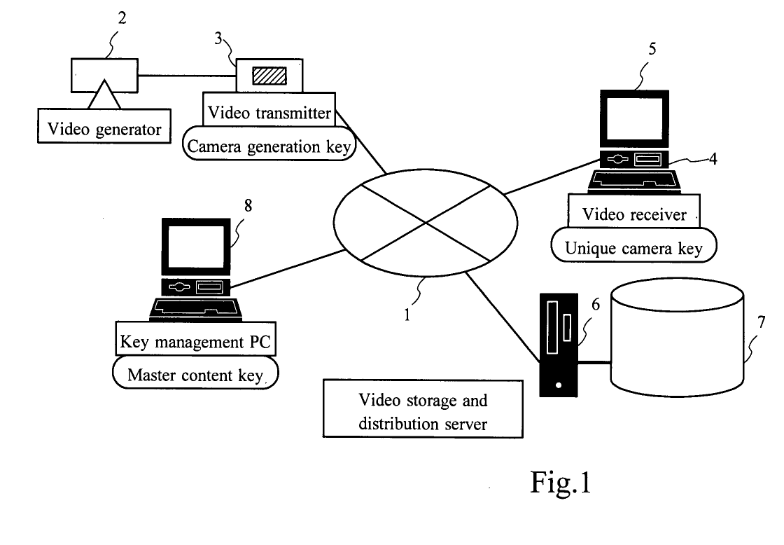

FIG. 1 shows the arrangement of an embodiment of the video distribution system of the invention. In the case of this system, the encrypted video data from the transmitter can be inspected at the receiving end, and therefore can be used as an encrypted network type video monitoring system. In the arrangement shown here in which audio is transmitted along with the video, the video data includes an audio data component. However, it is also possible to use a configuration in which the video and audio data are transmitted separately. While this embodiment is explained with specific reference to video data, the same processing can be applied to audio and other types of data.

The video distribution system comprises a network medium 1, a video generator 2, a video transmitter 3, a video receiver 4, a video display unit 5, a video storage and distribution server 6, a recording medium 7 and a key management personal computer (PC) 8. The network medium 1 is a network cable, a local area network (LAN) or a public network or the like over which transmitted data is sent. The network medium 1 may include network devices such as routers and hubs. The video transmitter 3, video receiver 4 and video storage and distribution server 6 are connected to the network medium 1, allowing communication between the devices. In the example of this embodiment, the key management PC 8 is also connected to the network medium 1.

The video generator 2 uses an imaging device, such as a video camera, to generate video images by converting light to electrical signals, and outputs the video image data thus generated to the video transmitter 3. The video transmitter 3 is, for example, an encoder that contains an interface for receiving the video image data from the video generator 2, an image codec and a network interface, converts the video images input from the video generator 2 to a format suitable for network transmission and transmits the result to the network medium 1. The video transmitter 3 also converts the video data to digital data when the video data received from the video generator 2 is analog data and, depending on the transmission band of the network medium 1, compresses the video. After using the prescribed set key to encrypt the digital video data, the video transmitter 3 sends the data to the network medium 1. Although in this embodiment the video generator 2 and video transmitter 3 are implemented as separate components, they may be integrated into a single apparatus.

The video receiver 4 is, for example, a decoder that contains a network interface, an image codec and an interface that outputs video to the video display unit 5. It receives video sent from the network medium 1, converts it to a format that enables it to be displayed by the video display unit 5, and outputs it to the video display unit 5. When the video display unit 5 is, for example, a TV monitor, the video receiver 4 also converts the video output to an analog output, and when the received video is encrypted, the video receiver 4 uses the specified key to decrypt the video. When the received video is compressed, the video receiver 4 uses the image codec to decompress the video. The video receiver 4 also incorporates an operating interface used to give the video storage and distribution server 6 replay commands such as Play and Fast Forward. The operating interface may be constituted by a computer graphical user interface (GUI) or a control panel terminal or the like connected to the video receiver 4.

The video display unit 5, which has a TV monitor, computer cathode ray tube (CRT) or a liquid crystal monitor device, converts the electric signals of the video input from the video receiver 4 to light for the display. Although in this embodiment the video receiver 4 and video display unit 5 are implemented as separate components, they may be integrated into a single apparatus that, for example, incorporates TV monitor functions, or is like a computer connected to a CRT, or is in the form of a portable terminal such as a mobile phone or the like equipped with a display device.

The video storage and distribution server 6 is, for example, a personal computer that has a network interface and an interface with the recording medium 7, receives video transmitted from the video transmitter 3 via the network medium 1, and records the video on the connected recording medium 7. In response to a video distribution request from the video receiver 4, the video storage and distribution server 6 also fetches the requested video from the recording medium 7 and sends it via the network medium 1 to the video receiver 4.

The recording medium 7 is, for example, a hard-disk or disk array that is connected with the video storage and distribution server 6 by a dedicated interface such as a Small Computer System Interface (SCSI), ATA (AT Attachment) or Fibre Channel interface, or an interface that uses an IP network such as Storage Area Network (SAN) or Network Attached Storage (NAS).

The key management PC 8 generates and manages keys used for data encryption and decryption. As one example, the system administrator inspects the screen of the key management PC 8 when the initial key settings are made in the video transmitter 3 and video receiver 4, and when these keys are changed. The administrator can set key values displayed on the screen of the key management PC 8 in both the video transmitter 3 and the video receiver 4 that receives the video from the video transmitter 3, and can also set a different key value in each device.

As another example, a configuration may be used in which the key management PC 8 communicates via the network medium 1 to set key values in both the video transmitter 3 and the video receiver 4 that receives the video from the video transmitter 3, or to set a different key value in each device, without the administrator inspecting the screen. As another example, an IC card or USB key that contains key value information is issued and used to set key values in each device.

The configuration shown in FIG. 1 has one video generator 2, one video transmitter 3, one video receiver 4 and one video display unit 5. However, a plurality of each of these devices may be connected to a single video storage and distribution server 6, and this also applies with respect to other devices. For example, the video storage and distribution server 6 can be simultaneously receiving and recording a plurality of different video images transmitted from a plurality of video transmitters 3, while at the same time distributing a plurality of different, desired video images to a plurality of video receivers 4. In one example, moreover, a video can be recorded by the video storage and distribution server 6 in response to a start recording instruction sent to the server 6 from the video receiver 4 or another device.

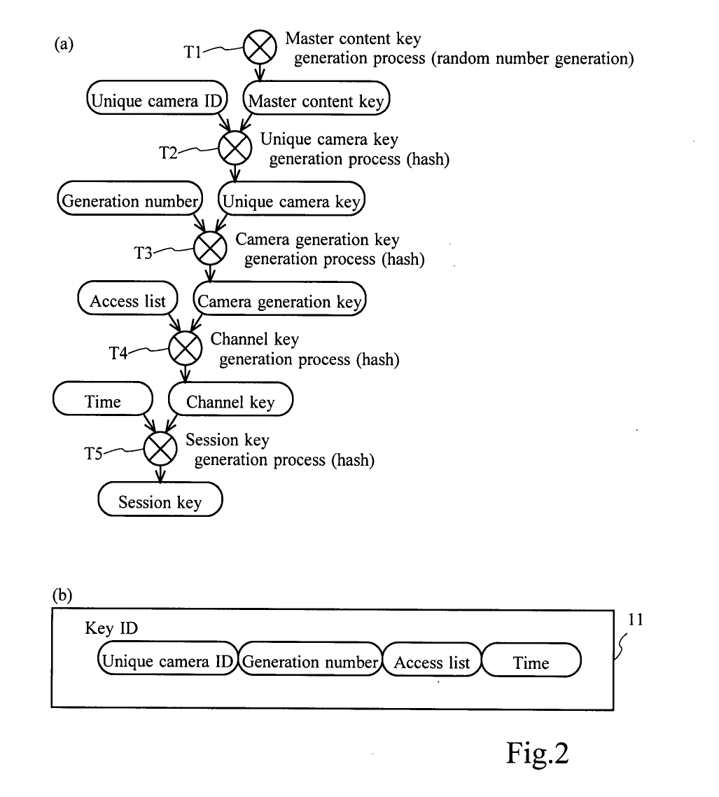

FIG. 2 (a) shows an example of hierarchical key generation, in which each key consists of a hexadecimal 64-digit value. As shown in FIG. 2 (a), master content key generation process T1, unique camera key generation process T2, camera generation key generation process T3, channel key generation process T4 and session key generation process T5 are performed.

The master content key generation process T1 uses a function such as pseudo-random number generation to generate a master content key. The unique camera key generation process T2 uses a one-way function (hash function) to generate a unique camera key from the master content key and unique camera ID. The unique camera value is a value that can manually or mechanically identify one among a plurality of video transmitters 3 in the system. For example, numbers such as 1, 2, 3 and so on may be used, or the string of characters of a name assigned by the administrator, such as Front Gate Surveillance Camera 1, or a MAC address, or IP address, or a manufacturer's serial number. As one example, in the case of a 6-byte MAC address in which the leading three bytes are a unique vendor value and the trailing three bytes are a device (video transmitter 3) identification value, the trailing three bytes of the MAC address can be used as a unique camera ID.

The camera generation key generation process T3 uses a one-way function (hash function) to generate a camera generation key from the unique camera ID and the generation number. The generation number may be a number such as 1, 2, 3 and so on, and is updated whenever a key set in the video transmitter 3 is changed because, for example, the key has been leaked. The channel key generation process T4 uses a one-way function (hash function) to generate a channel key from the camera generation key and the access list. For the access list, there may be used character strings denoting information types or numbers and the like determined on a content by content basis, such as character strings of user names, user numbers, “video” or “audio” or “character strings (such as on-screen song titles)” and “sensor information” and the like showing encryption target differences. The session key generation process T5 uses a one-way function (hash function) to generate a session key from a channel key and time. The time can be comprised of the year, month, day, hour, minute and second, or a numerical value expressing just part thereof. Unique camera IDs, generation numbers, access lists and times are expressed hexadecimally, for example.

FIG. 2 (b) shows an example of the configuration of key ID 11. Key ID 11 is data that includes a unique camera ID, a generation number, an access list and a time. Because the combination of unique camera ID, generation number, access list and time is unique, all keys (each unique camera key, camera generation key, channel key and session key) can be specified from the key ID 11. In the video transmitter 3, the key ID 11 is assigned to video data encrypted using a corresponding key, and the set of key ID 11 and encrypted video data is transmitted from the video transmitter 3 to the video receiver 4 and video storage and distribution server 6. In this embodiment, the encrypted video data and the key used in the encryption are transmitted together with a specific key ID. However, another configuration that can be used is one in which, on the receiving side, the encrypted data and key ID comprising a set (relational correspondence) can be grasped and each sent separately.

The key ID 11 is assigned not at the start of a connection (login), but is instead assigned each time to the video (or audio or other) data header. As the time, there may be used the conventional date and time (year, month, day, hour, minute and second information) assigned to the video (or audio or other) data. If for example just year, month and day information is extracted and used, the system becomes one in which session keys change once a day. The system can also be implemented as one in which session keys change a plurality of times per day, based on date and time information. The process of generating a session key from key ID 11 does not have to be performed each time video data is received. Instead, a comparison to the previous key ID 11 can be made, and a new session key generated only when the comparison shows the current key ID 11 has changed. It is also possible to use a configuration that generates a session key for each session. It is preferable to make the data amount of the key ID 11 a relatively small 1/100 or 1/1000 of the encrypted video data.

FIG. 1 shows an example of a preferred arrangement when the hierarchical keys are set in each system device. Here, a master content key is set in the key management PC 8, a unique camera key is set in the video receiver 4, a camera generation key is set in the video transmitter 3, and no key is set in the video storage and distribution server 6. Not setting a key in the server 6 prevents leakage of video data, even in the event of the theft of the server 6 and recording medium 7.

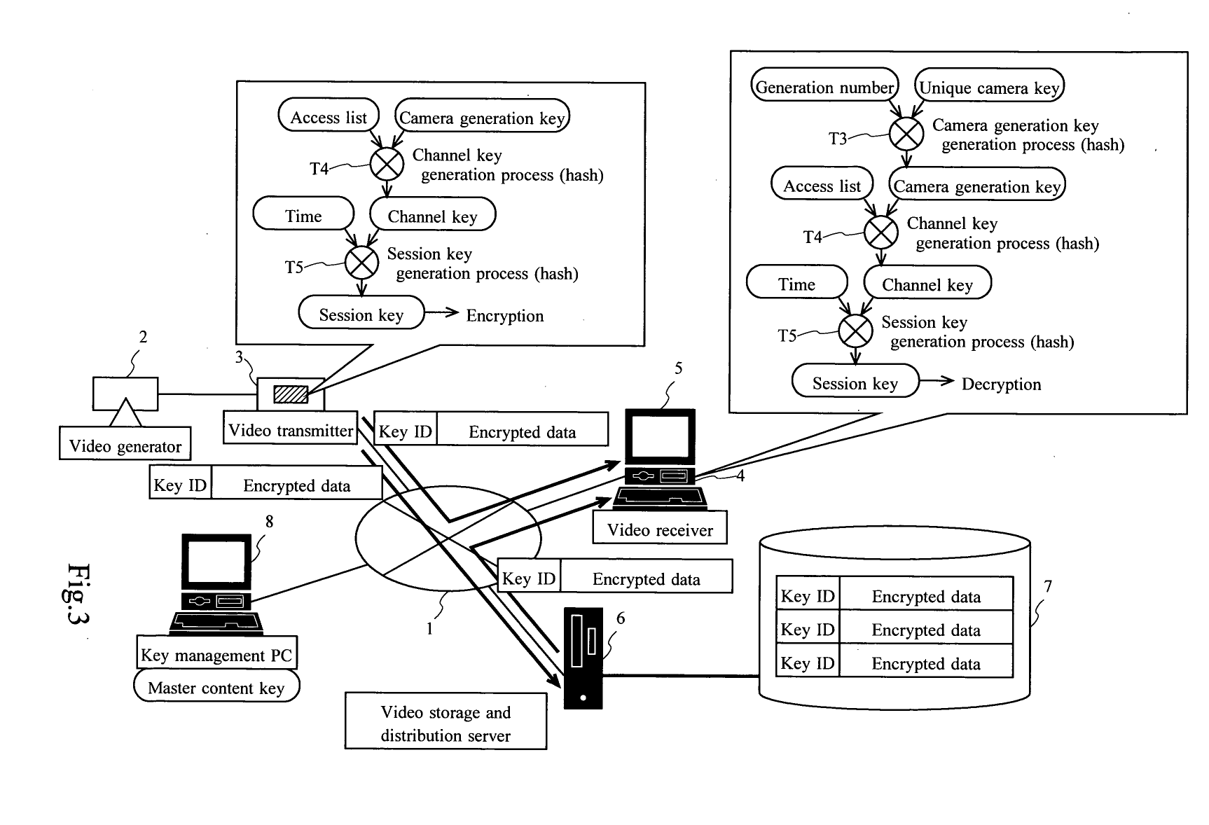

FIG. 3 shows an example of the encryption and decryption procedures performed by the video distribution system. First, in the video transmitter 3, the channel key generation process T4 is used to generate a channel key from the set camera generation key and access list, and the session key generation process T5 is used to generate a session key from the channel key and the time. At the video transmitter 3, the session key is used as the actual encryption key, and the encrypted video data is transmitted to the video receiver 4 and the video storage and distribution server 6, along with the key ID 11 containing the unique camera ID, generation number, access list and time.

In the video storage and distribution server 6, the encrypted video data received from the video transmitter 3, together with the key ID 11, is stored on the recording medium 7. When the video receiver 4 receives the encrypted video data from the video transmitter 3 and video storage and distribution server 6, it calculates the key used for the encryption from the key ID 11 (unique camera ID, generation number, access list and time) received with the encrypted video data and the unique camera key set in the video receiver 4. Specifically, using the unique camera key corresponding to the unique camera ID, the camera generation key generation process T3, channel key generation process T4 and session key generation process T5 are performed to calculate the session key used in the encryption. Next, the video receiver 4 uses the calculated session key to decrypt the corresponding video data and displays the decrypted data on the screen of the video display unit 5.

Using this configuration that sets the master content key in the key management PC 8 enables the time and effort required to store numerous keys beforehand in the key management PC 8 to be reduced, and decreases the amount of memory required.

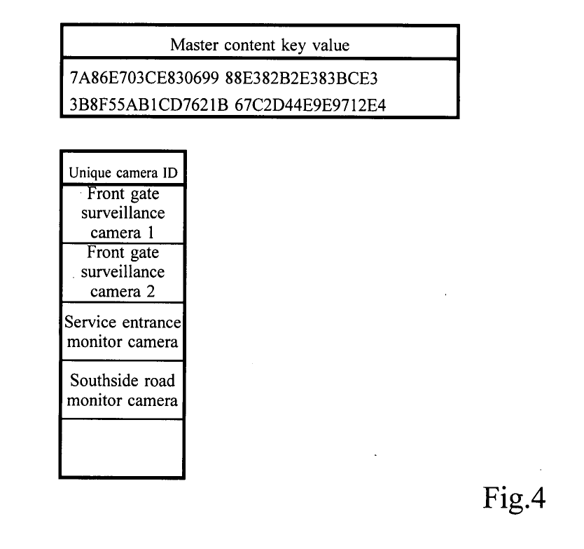

FIG. 4 shows an example of the master content key value stored in the key management PC 8. In this embodiment, the unique IDs of each camera are stored on the key management PC 8 together with the master content key value. Unlike in the case shown in FIG. 8, with this arrangement it is not necessary to store individual key values corresponding to each of the unique camera IDs; only the master content key value needs to be stored.

The key management PC 8 possesses the functions of the master content key generation process T1, unique camera key generation process T2 and camera generation key generation process T3, providing the functions of inspecting the camera generation key set in the video transmitter 3 and the unique camera key set in the video receiver 4.

This configuration in which the unique camera key is set in the video receiver 4 and the camera generation key, which is a lower-order key, calculated, enables the time and effort required to set and store numerous keys in the video receiver 4 to be reduced, and decreases the amount of memory required. It also eliminates the need to set key values associated precisely with key change times measured in milliseconds.

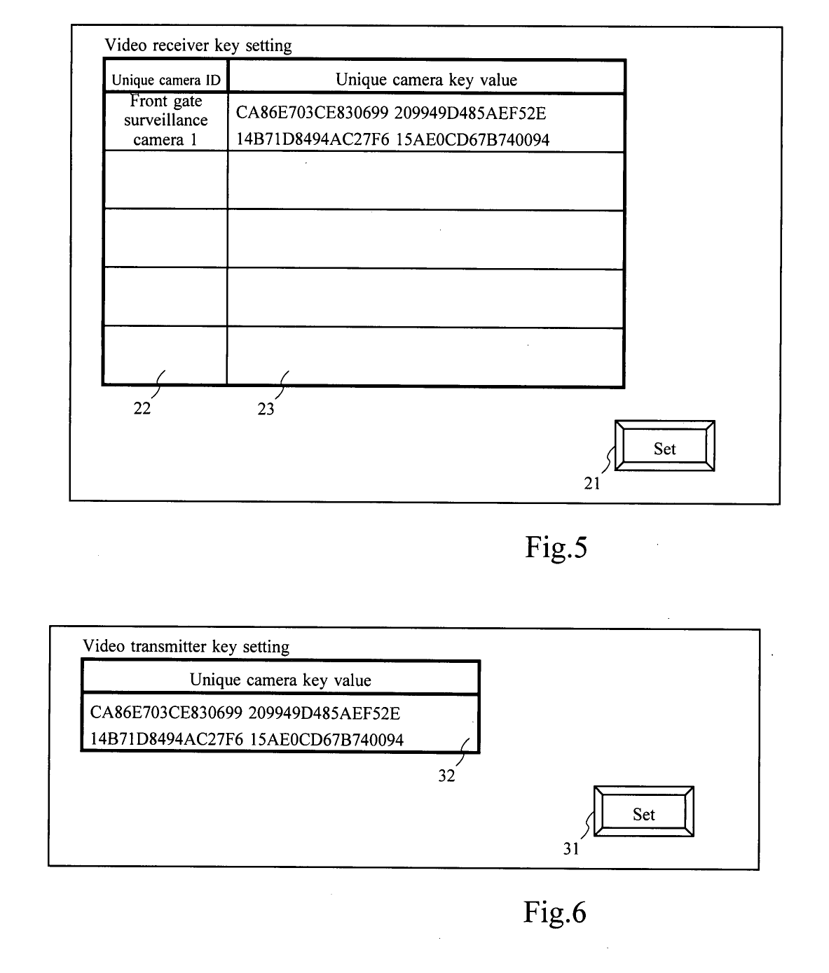

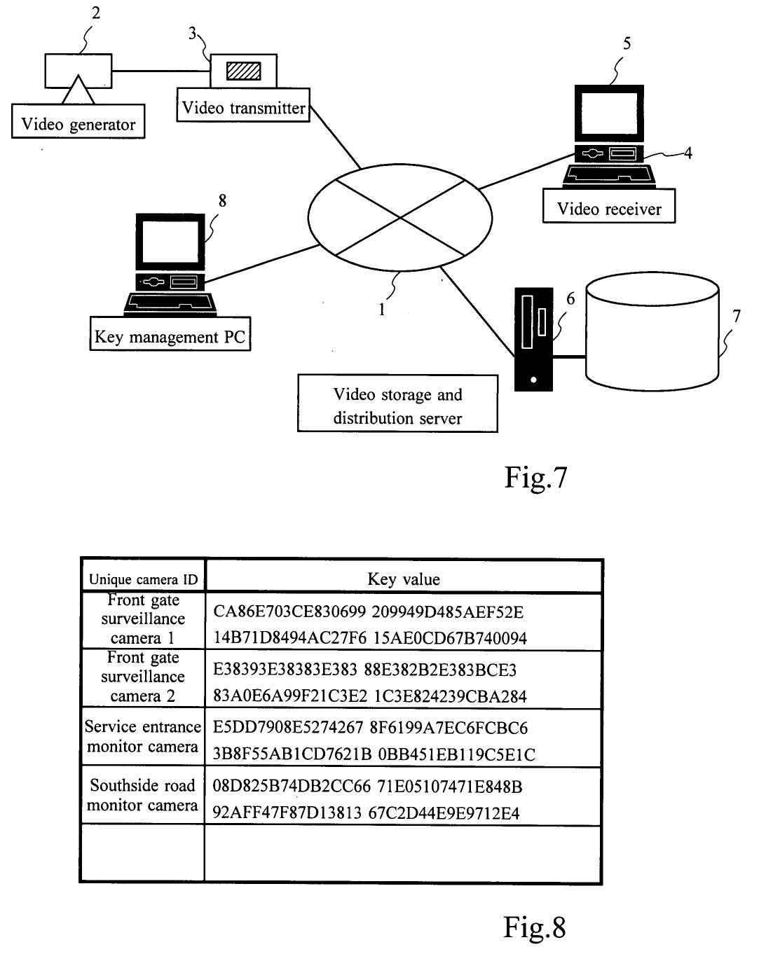

FIG. 5 shows an example of a key setting screen in the video receiver 4. Displayed on the setting screen are a set button 21, a unique camera ID input column 22 and a unique camera key value input column 23. The set button 21 is used to confirm the content input to each column and instruct the system to hold the content in the internal memory of the video receiver 4. The unique ID of the camera is input to the camera ID input column 22. The unique camera key value is input to the unique camera key value input column 23.

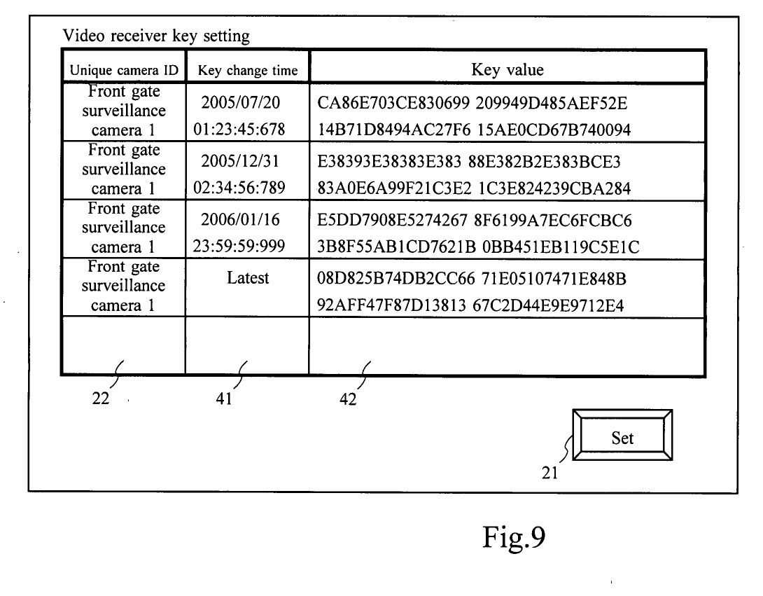

A comparison of this example with that of FIG. 9 shows that the key change time input column 41 has been eliminated, reducing the number of input items. This configuration in which the camera generation key is set in the video transmitter 3 and the channel key, which is a lower-order key, calculated, enables the time and effort required to set and store, by access list, numerous keys in the video transmitter 3 to be reduced, and decreases the amount of memory required. FIG. 6 shows an example of a key setting screen in the video transmitter 3. Displayed in the setting screen are a set button 31 and a camera generation value input column 32. The set button 31 is used to confirm the content input to each column and instruct the system to retain the content in the internal memory of the video transmitter 3. The camera generation key value is input to the column 32.

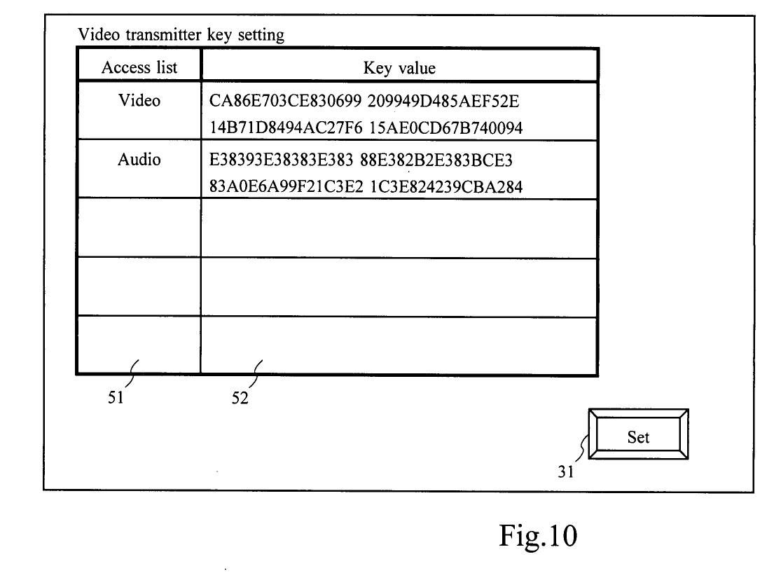

A comparison of this example with that of FIG. 10 shows that the access list input column 51 has been eliminated, reducing the number of key values that are set. The need for the access list input column 51 is eliminated because it is not necessary to associate key values with an access list such as “video” or “audio” or the like. In the case of this example, moreover, since the session key is calculated from the channel key and a time, the time and effort required to reset keys in the video transmitter 3 and video receiver 4 are reduced when it is desired to sometimes change keys.

Since in this case it is a camera generation key that is set in the video transmitter 3, not a unique camera key, there is no need to reset the unique camera key in the video receiver 4 in the event that the camera generation key is leaked, for example. Instead, all that has to be done is to update to a new camera generation key calculated by increasing the generation number of the camera generation key of the video transmitter 3.

In this embodiment, also, since a unique camera key, not a camera generation key, is set in the video receiver 4, when the video receiver 4 receives past video data from the video storage and distribution server 6 and it is desired to play video data encrypted using an old camera generation key (in practice, using a session key calculated from an old camera generation key), the old camera generation key can be calculated from the unique camera key (in practice, using another calculated session key) and used to decrypt and play the data.

Thus, the camera generation key, which is a lower-order key, is set in the video transmitter 3, and the unique camera key, which is a higher-order key, is set in the video receiver 4. Alternatively, keys of the same level can be set in the video transmitter 3 and video receiver 4, or a higher-order key (a unique camera key, for example) may be set in the video transmitter 3 and a lower-order key (a camera generation key, for example) set in the video receiver 4. If, for example, a camera generation key is set in the video receiver 4, it will only be possible for the video receiver 4 to play current generation video (such as live video, for example). Normally, the lower the order of a key set in a system unit, the more time and effort it takes to change the setting, but the more safe it is when there has been a leak.

In this embodiment the elements unique camera ID, generation number, access list and time were used to generate a session key from the master content key. However, some elements can be omitted, such as the access list, for example. As one example, the same value (a fixed value) could be used with respect to access list values for all the data. Similarly, although this embodiment has been described with respect to a hierarchical flow from higher-order to lower-order keys in the order master content key, unique camera key, camera generation key, channel key and session key, other orders may be used, and a flow from higher-order to lower-order keys may be used that differs from that of this embodiment.

As described in the foregoing, when in the video distribution system of this invention video encrypted in the video transmitter 3 is transmitted via the network medium 1 to the video receiver 4 and decrypted, a key hierarchy is implemented that calculates keys, going from higher-order keys to lower-order keys. The setting of keys can be simplified by sending the key ID 11 containing the values used during the calculation along with the encrypted video. The video distribution system is also equipped with a video storage and distribution server 6. The server 6 receives and stores the key ID 11 along with the encrypted video data, and retransmits the key ID 11 and encrypted video to the video receiver 4.

Also, the key provided in each video receiver 4 (unique camera key, in this example) is calculated from a single key (the master content key, in this example) and a value (unique camera ID, in this example) that specifies the video transmitter 3, making it possible to only have to manage one higher-order key (the master content key, in this example). Also, when encrypted video retransmitted from the video storage and distribution server 6 is played by the video receiver 4, by using a system in which a lower-order key (camera generation key, in this example) is calculated from a certain key (a unique camera key, in this example) taken to be a higher-order key and a generation number that signifies the number of setting changes, and the lower-order key is set in the video transmitter 3 and the higher-order key is set in the video receiver 4, it is possible to have the key set in the video receiver 4 be only a lower-order key, even when the key set in the video transmitter 3 is changed.

Also, when the system processing is performed using a key (a channel key, in this example) associated with a plurality of different types of data in the video transmitter 3, by calculating a lower-order key (a channel key, in this example) from a certain key (a camera generation key, in this example) taken to be a higher-order key, and an access list, it is possible to have only the higher-order key be the key set externally in the video transmitter 3. Also, when a key is changed to prevent it being decoded in the video transmitter 3, by calculating a lower-order key (a session key, in this example) from a certain key (a channel key, in this example) taken to be a higher-order key, and a time, it is possible to have only a higher-order key (a camera generation key or unique camera key, in the case of this example) be the key set externally in the video transmitter 3 and video receiver 4.

This system uses a master content key as the highest-order key, a unique camera key as the next high-order key, a camera generation key as the next high-order key, and a channel key as the next high-order key. The session key is used as the lowest-order key. The elements used to generate the keys, going from higher-order to lower-order, are unique camera ID (originator identification value), generation number (number-of-updates identification value), access list (type identification value), and time (time identification value). The information of the key ID 11 is used as element information added to the encrypted data.

The transmitter (video transmitter 3) is equipped with the function of the transmission-side storage means of storing camera generation keys, the function of the transmission-side generation means of generating session keys, the function of the encryption means of encrypting data using session keys, and the function of the transmission means for transmitting encrypted data and the key ID 11.

The receiver (video receiver 4) is equipped with the function of the receiving means of receiving the encrypted data and key ID 11, the function of the receiving-side storage means of storing unique camera key, the function of the receiving-side generation means of generating session keys, and the function of the decryption means of decrypting encrypted data using session keys.

Encrypted data and key ID 11 can also be transmitted via a store-and-forward apparatus (video storage and distribution server 6 and recording medium 7).

The configuration of the system and apparatus according to the present invention is not limited to that set out in the foregoing, various other configurations also being possible. This invention may be provided as a program for effecting the methods of executing the processing of this invention, or as said program recorded on a recording medium. In addition, the field of application of the invention is not necessarily limited to that described in the foregoing, application of the invention to various other fields also being possible.

Moreover, the various processes performed in the system or apparatus of the invention may be implemented in hardware resources equipped with a processor and memory and the like, controlled by means of a processor executing a control program stored in ROM (Read Only Memory), for example. The various functional means for executing this processing may also be constituted as independent hardware circuits.

In addition, the present invention may also be understood as one wherein the above control program is stored on a Floppy disc, CD (Compact Disc)-ROM or other computer-readable recording medium, so that the processing according to the present invention can be implemented by said control program being input from the recording media into a computer and executed by a processor.

What is claimed is:

1. A video distribution system for distributing encrypted video data,
wherein said video distribution system performs data encryption and decryption using a lowest-order key generated by a system that uses hierarchical keys obtained in a case in which a highest-order key is set, one or more elements and an order thereof are set, and the elements are used one by one to generate keys of a gradually lower order than the highest-order key in accordance with the order of the elements.

2. A video distribution system according to claim 1 that has a transmitter for transmitting encrypted data and a receiver for receiving encrypted data,
the transmitter comprising transmission-side storage means for storing a specific key of a higher order than a lowest-order key; transmission-side generation means for generating a lowest-order key, using a key stored in the transmission-side storage means and one or more elements; encryption means for encrypting data, using a lowest-order key generated by the transmission-side generation means; and transmission means for transmitting the data encrypted by the encryption means and the element information for generating the key used in said encryption;
the receiver comprising receiving means for receiving the encrypted data and the element information; receiving-side storage means for storing a specific key of a higher order than a lowest-order key; receiving-side generation means for generating a lowest-order key using a key stored in the receiving-side storage means and elements specified by information received by the receiving means; and decryption means for decrypting encrypted data received by the receiving means, using the lowest-order key generated by the receiving-side generation means.

3. A video distribution system according to claim 2, wherein the elements that are used are one or more selected from among an originator identification value that identifies the originator of the encrypted data, a number-of-updates identification value that identifies the number of times a key has been updated at the originator of the encrypted data, and a type identification value that identifies the data type.

4. A video distribution system according to claim 3, wherein the elements are an originator identification value that identifies the originator of the encrypted data, a number-of-updates identification value that identifies the number of times a key has been updated at the originator of the encrypted data, a type identification value that identifies the data type, and a time identification value that identifies the time, used going from higher order to lower order.

5. A video distribution system according to claim 4, wherein the elements used are at least an originator identification value that identifies the originator of the encrypted data and a number-of-updates identification value that identifies the number of times a key has been updated at the originator of the encrypted data;
a key generated using the number-of-updates identification value is stored in the encrypted data transmission-side storage means; and
a key generated using the originator identification value is stored in the encrypted data receiving-side storage means.
